(19) United States
(12) Patent Application Publication
(10) Pub. No.: US 2020/0209932 A1
(43) Pub. Date: Jul. 2, 2020

(54) SYSTEM AND DEVICE

(71) Applicant: FUJITSU CLIENT COMPUTING LIMITED, Kanagawa (JP)

(72) Inventor: Hiroki Teramoto, Kawasaki (JP)

(73) Assignee: FUJITSU CLIENT COMPUTING LIMITED, Kanagawa (JP)

(21) Appl. No.: 16/690,659

(22) Filed: Nov. 21, 2019

(30) Foreign Application Priority Data
Dec. 28, 2018 (JP) 2018-247562

(51) Int. Cl. G06F 1/26; G06F 13/10

(52) U.S. Cl. CPC G06F 1/266; G06F 13/102

(57) ABSTRACT

A system includes: a first platform, a second platform, and a relay device including an expansion bus that connects to the first and the second platforms. The first platform includes a processor that detects an abnormality in communication between the first and the second platforms through the expansion bus. The relay device includes a communication control microcomputer that controls the communication between the first and the second platforms through the expansion bus, and a power supply control microcomputer that controls supply of power from an external power supply to the second platform, and determines, after the abnormality has been detected in the communication between the first and the second platforms through the expansion bus, that the abnormality is caused by one of hardware and software, based on an electrical signal from the second platform, and notifies the first platform of a result of the determination.

### CROSS-REFERENCE TO RELATED APPLICATIONS

This application is based upon and claims the benefit of priority from Japanese Patent Application No. 2018-247562, filed Dec. 28, 2018, the entire contents of which are incorporated herein by reference.

### FIELD

An embodiment described herein relates generally to a system and a device.

### BACKGROUND

Techniques have been developed in which, in an information processing system including a host personal computer (PC), processors, and a relay device connectable to the host PC and the processors, the relay device provides communication between the host PC and the processors connected to slots by providing a virtual local area network (LAN) using an expansion bus, such as a Peripheral Component Interconnect Express (PCIe).

However, in the above-described techniques, when an abnormality has occurred in the communication between the host PC and the processors, it is difficult to determine whether the abnormality in the communication is caused by hardware or software. Thus, no appropriate error handling can be performed in a manner suited to the abnormality in the communication between the host PC and computing units through the expansion bus.

### SUMMARY

According to one aspect of this disclosure, in general, a system includes a first platform, a second platform, and a relay device including an expansion bus connectable to the first platform and the second platform, wherein the first platform includes a processor that detects an abnormality in communication between the first platform and the second platform through the expansion bus, and the relay device includes a communication control microcomputer that controls the communication between the first platform and the second platform through the expansion bus, and a power supply control microcomputer that controls supply of power from an external power supply to the second platform, and that, after the abnormality has been detected in the communication between the first platform and the second platform through the expansion bus, determines, based on an electrical signal from the second platform, that the abnormality in the communication between the first platform and the second platform through the expansion bus is caused by one of hardware and software, and notify the first platform of a result of the determination.

According to another aspect of this disclosure, in general, a device includes an expansion bus connectable to a first platform and a second platform, a communication control microcomputer that controls communication between the first platform and the second platform through the expansion bus, and a power supply control microcomputer that controls supply of power to the second platform, and that, after an abnormality has been detected in the communication between the first platform and the second platform through the expansion bus, determines, based on an electrical signal from the second platform, that the abnormality in the communication between the first platform and the second platform through the expansion bus is caused by one of hardware and software, and notify the first platform of a result of the determination.

### BRIEF DESCRIPTION OF THE DRAWINGS

FIG. 1 is a diagram illustrating an example of an overall configuration of an information processing system according to an embodiment;

FIG. 2 is a diagram illustrating an example of a hardware configuration of the information processing system according to the embodiment;

FIG. 3 is a diagram illustrating an example of a software configuration of platforms of the information processing system according to the embodiment;

FIG. 4 is a diagram for explaining an example of communication processing between the platforms in the information processing system according to the embodiment;

FIG. 5 is a diagram illustrating an example of how any one of the platforms recognizes the other of the platforms in the information processing system according to the embodiment;

FIG. 6 is a diagram illustrating another example of how any one of the platforms recognizes the other of the platforms in the information processing system according to the embodiment;

FIG. 7 is a diagram for explaining an example of a method for data transfer between processors through a relay device in the information processing system according to the embodiment;

FIG. 8 is a block diagram illustrating an example of a functional configuration of the information processing system according to the embodiment; and

FIG. 9 is a sequence diagram illustrating an example of a flow of processing of determining an abnormality in communication in the information processing system according to the embodiment.

### DETAILED DESCRIPTION

The following describes a system including a device according to an embodiment, using the accompanying drawings.

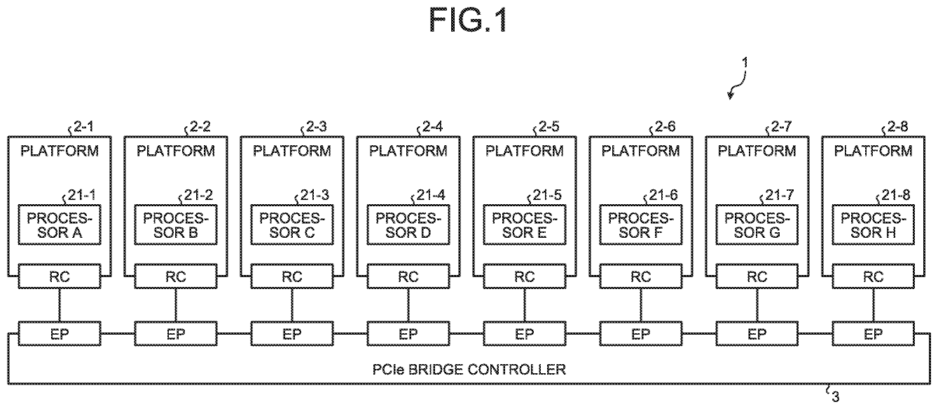

FIG. 1 is a diagram illustrating an example of an overall configuration of the information processing system according to the present embodiment. As illustrated in FIG. 1, an information processing system 1 according to the present embodiment includes a plurality of platforms 2-1 to 2-8 and a relay device 3. Each of the platforms 2-1 to 2-8 is connected to the relay device 3.

In the following description, each of the platforms 2-1 to 2-8 will be referred to as a platform 2 when need not be distinguished from the other platforms and representing any of the platforms. Although an example will be described herein in which the information processing system 1 includes the eight platforms 2-1 to 2-8, the information processing system 1 is not limited thereto as long as including a plurality of the platforms 2.

Each of the platforms 2-1 to 2-8 is a host personal computer (PC) that serves as a control unit and a graphical user interface (GUI) of the information processing system 1, or is a computing unit that performs, for example, artificial intelligence (AI) inference processing and image processing.

Specifically, the platforms 2-1 to 2-8 include processors 21-1 to 21-8. In the following description, each of the processors 21-1 to 21-8 will be referred to as a processor 21 when need not be distinguished from the other processors and represent any of the processors. The processors 21-1 to 21-8 may be provided by respective different makers (vendors), or provided by the same maker.

For example, it is assumed that the processor 21-1 is provided by Company A, the processor 21-2 by Company B, the processor 21-3 by Company C, the processor 21-4 by Company D, the processor 21-5 by Company E, the processor 21-6 by Company F, the processor 21-7 by Company G, and the processor 21-8 by Company H.

Each of endpoints (EPs) mounted on the relay device 3 may be connected to different one of the platforms 2. Alternatively, one of the platforms 2 may be connected to each of the EPs, and the platform 2 may communicate with the relay device 3 using a plurality of root complexes (RCs).

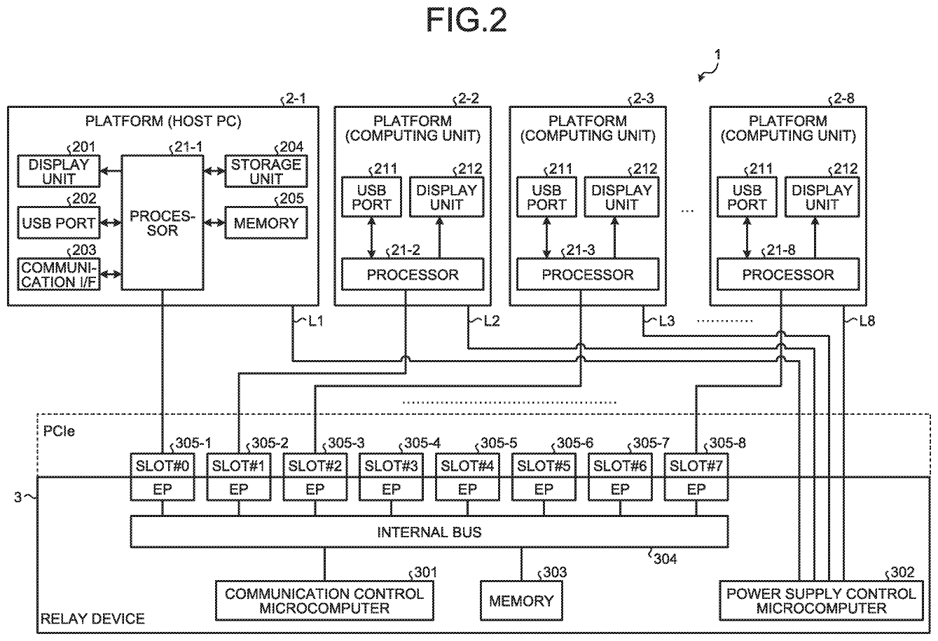

The following describes an example of a hardware configuration of the information processing system 1 according to the present embodiment, with reference to FIG. 2. FIG. 2 is a diagram illustrating the example of the hardware configuration of the information processing system according to the present embodiment. The following describes an example in which the platform 2-1 serves as the host PC, and each of the platforms 2-2 to 2-8 serves as the computing unit that performs, for example, the AI inference processing and the image processing.

First, the following describes the hardware configuration of the platform 2-1 that serves as the host PC.

As illustrated in FIG. 2, the platform 2-1 includes the processor 21-1, a display unit 201, a Universal Serial Bus (USB) port 202, a communication interface (I/F) 203, a storage unit 204, and a memory 205. The display unit 201 is, for example, a liquid crystal display (LCD), and displays various types of information. The USB port 202 is a connector for connecting the platform 2-1 to a peripheral device. The communication I/F 203 enables communication with a network, such as a local area network (LAN), according to a communication standard, such as Ethernet (registered trademark).

The storage unit 204 is a storage device, such as a hard disk drive (HDD), a solid-state drive (SSD), or a storage class memory (SCM), and stores therein various types of data. The memory 205 is, for example, a read-only memory (ROM) or a random access memory (RAM). The ROM stores therein various software programs and data for the software programs. The software programs stored in the ROM are read and executed by the processor 21-1. The RAM serves as a work area when each of the software programs stored in the ROM is executed.

The processor 21-1 is a processor, such as a central processing unit (CPU), a microprocessing unit (MPU), a digital signal processor (DSP), an application specific integrated circuit (ASIC), a programmable logic device (PLD), or a field programmable gate array (FPGA), and controls the entire platform 2-1. The processor 21-1 may be a multi-core processor, or a combination of two or more processors.

Subsequently, the following describes the hardware configuration of the platforms 2-2 to 2-8 each serving as the computing unit that performs, for example, the AI inference processing and the image processing.

As illustrated in FIG. 2, the platform 2-2 includes the processor 21-2, a USB port 211, and a display unit 212. The display unit 212 is, for example, an LCD, and displays various types of information. The USB port 211 is a connector for connecting the platform 2-2 to a peripheral device.

The processor 21-2 is a processor, such as a CPU, an MPU, a DSP, an ASIC, a PLD, or an FPGA, and controls the entire platform 2-2. The processor 21-2 may be a multi-core processor, or a combination of two or more processors. For example, the processor 21-2 may be a combination of a CPU and a graphics processing unit (GPU).

The hardware configuration of the platform 2-2 has been described herein. The same hardware configuration is also employed in each of the other platforms 2-3 to 2-8 serving as the computing unit that performs, for example, the AI inference processing and the image processing.

The following describes the hardware configuration of the relay device 3.

As illustrated, for example, in FIG. 2, the relay device 3 is a relay device that includes the EPs in one chip. As illustrated in FIG. 2, the relay device 3 includes a communication control microcomputer 301, a power supply control microcomputer 302, a memory 303, and a plurality of slots 305-1 to 305-8. As illustrated in FIG. 2, the communication control microcomputer 301, the memory 303, and the slots 305-1 to 305-8 are connected so as to be capable of communicating with one another through an internal bus 304.

As illustrated in FIG. 2, the power supply control microcomputer 302 is connected through signal lines L1 to L8 to the platforms 2-1 to 2-8 that are connected to the slots 305-1 to 305-8. The signal lines L1 to L8 are signal lines that transmit signals received from the platforms 2-1 to 2-8 to the power supply control microcomputer 302.

Each of the slots 305-1 to 305-8 is an example of an expansion slot (expansion bus) to which a device that meets the PCIe standard is connected. In the present embodiment, the platforms 2-1 to 2-8 are connected to the slots 305-1 to 305-8. In the following description, each of the slots 305-1 to 305-8 will be referred to as a slot 305 when need not be distinguished from the other slots and representing any of the slots.

One of the platforms 2 may be connected to one of the slots 305, or a plurality of the platforms 2 may be connected to one of the slots 305. In addition, assigning a plurality of the slots 305 to one of the platforms 2 allows the platform 2 to communicate using a wide communication band.

The memory 303 is a memory that includes a ROM and a RAM. The ROM of the memory 303 stores therein various software programs including, for example, a software program related to communication control between the platforms 2 connected to the slots 305, and data for the software programs. The software programs stored in the ROM are read and executed by the communication control microcomputer 301. The RAM of the memory 303 serves as a work area when each of the software programs stored in the ROM of the memory 303 is executed.

The platform 2 is provided with a memory area in, for example, a memory 22 corresponding to each of the slots 305. A plurality of storage areas divided into the number of the slots 305 are set in the memory area, and each of the storage areas is associated with any one of the slots 305. The relay device 3 transfers data between the platforms 2 based on an address of the storage area provided for each of the slots 305.

The communication control microcomputer 301 includes a processor, such as a CPU, an MPU, a DSP, an ASIC, a PLD, or an FPGA, and the processor controls the communication between the platforms 2 through the slots 305. The communication control microcomputer 301 may include a combination of a plurality of processors. The communication control microcomputer 301 executes the software program stored in the memory 303 to perform the communication between the platforms 2 connected to the slots 305.

The power supply control microcomputer 302 includes a processor, such as a CPU, an MPU, a DSP, an ASIC, a PLD, or an FPGA, and the processor controls the supply of power to the platforms 2 connected to the slots 305. The processor of the power supply control microcomputer 302 may include a combination of a plurality of processors. The processor of the power supply control microcomputer 302 executes a software program stored in a memory included in the power supply control microcomputer 302 to supply the power from a power supply unit (not illustrated) to the platforms 2 connected to the slots 305.

In the present embodiment, to increase the speed of the communication between the platforms 2, the relay device 3 operates the processor 21 provided on the platform 2 as each of the RCs using the PCIe to transfer the data between the EPs that operate as devices, as illustrated in FIG. 2.

Specifically, in the information processing system 1, the processor 21 of each of the platforms 2 is operated as the RC of the PCIe. The relay device 3 (that is, the slots 305 connected to the respective platforms 2) is operated as the EPs for the processors 21 of the respective platforms 2.

Various known techniques can be used to connect the relay device 3, as the EPs, to the processors 21 of the platforms 2. For example, in order to be connected to the platforms 2, the relay device 3 notifies the platforms 2 of a signal indicating that the relay device 3 serves as the EPs, and is connected, as the EPs, to the platforms 2.

The relay device 3 transfers the data to the RCs by tunneling the data from endpoint to endpoint (from EP to EP). The communication between the processors 21 of the platforms 2 is logically connected when a transaction of the PCIe has occurred, and the data can be transferred in parallel between the processors 21 unless the data transfer is concentrated on one of the processors 21.

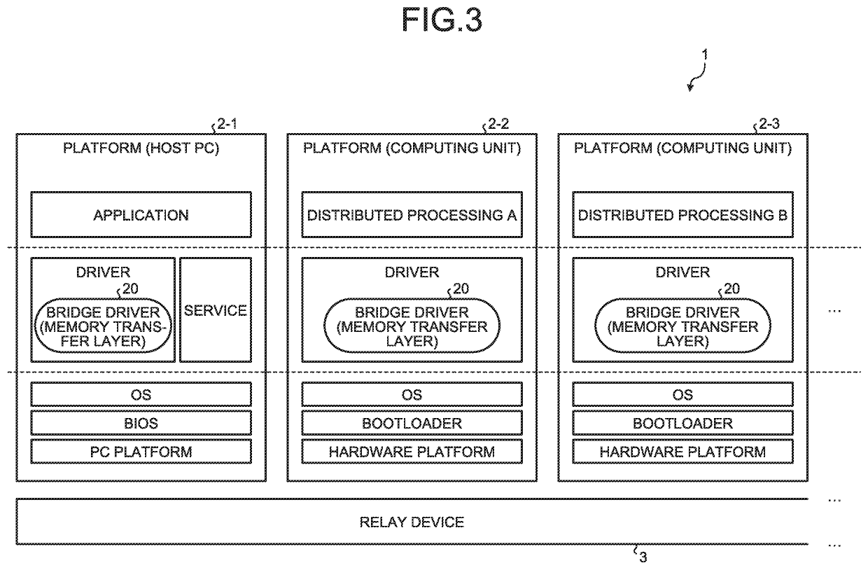

The following describes an example of a software configuration of the platforms 2 of the information processing system 1 according to the present embodiment, with reference to FIG. 3. FIG. 3 is a diagram illustrating the example of the software configuration of the platforms of the information processing system according to the present embodiment.

The platform 2-1 uses, for example, Windows (registered trademark) as an operating system (OS), and executes the various software programs on this OS. The platforms 2-2 and 2-3 use, for example, Linux (registered trademark) as an operating system (OS), and execute the various software programs on this OS.

The platform 2 includes a bridge driver 20, and communicates with the relay device 3 and the other platforms 2 through the bridge driver 20. Each of the platforms 2 includes the processor 21 and the memory. The processor 21 executes, for example, the OS, the various programs, and drivers stored in the memory to perform various functions included in the platform 2.

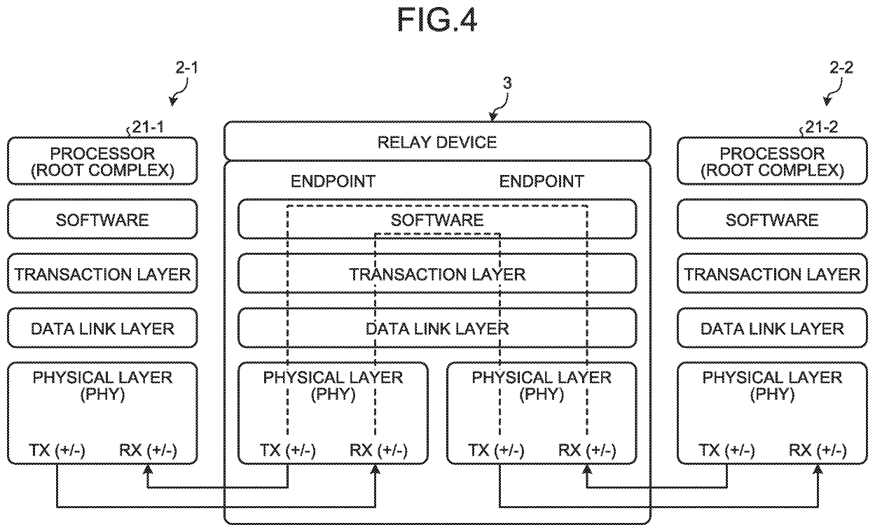

The following describes an example of communication processing between the platforms 2 connected to the relay device 3, with reference to FIG. 4. FIG. 4 is a diagram for explaining the example of the communication processing between the platforms in the information processing system according to the present embodiment. The example will be described herein regarding the communication processing between the processor 21-1 of the platform 2-1 and the processor 21-2 of the platform 2-2.

On the platform 2-1 serving as a transmission source, data generated by the processor 21-1 serving as the RC is sequentially transferred from software through a transaction layer and a data link layer to a physical layer (PHY), and transferred from the physical layer to the physical layer of the relay device 3.

The relay device 3 sequentially transfers the data transferred from the platform 2-1 serving as the transmission source from the physical layer through the data link layer and the transaction layer to the software, and then, transfers, by tunneling, the data to the EP corresponding to the RC of the platform 2-2 serving as a transmission destination. In other words, in the relay device 3, the data is transferred from one of the RCs (processor 21-1) to another of the RCs (processor 21-2) by tunneling the data between the EPs.

On the platform 2-2 serving as the transmission destination, the data transferred from the relay device 3 is sequentially transferred from the physical layer (PHY) through the data link layer and the transaction layer to the software, and then, transferred to the processor 21-2 of the platform 2-2 serving as the transmission destination. In the information processing system 1 of the present embodiment, the communication between the platforms 2 is logically performed when the transaction of the PCIe has occurred.

Unless the data transfer from the platforms 2 is concentrated on the platform 2 connected to one of the slots 305 included in the relay device 3, the data can also be transferred in parallel between any plurality of different sets of the platforms 2. For example, if the processor 21-2 of the platform 2-2 and the processor 21-3 of the platform 2-3 communicate with the processor 21-1 of the platform 2-1, the relay device 3 serially processes the communication performed by the processor 21-2 of the platform 2-2 and the processor 21-3 of the platform 2-3.

Otherwise, if the processors 21 of the different platforms 2 communicate with each other and the communication is not concentrated on the processor 21 of particular one of the platforms 2, the relay device 3 can process the communication between the platforms 2 in parallel.

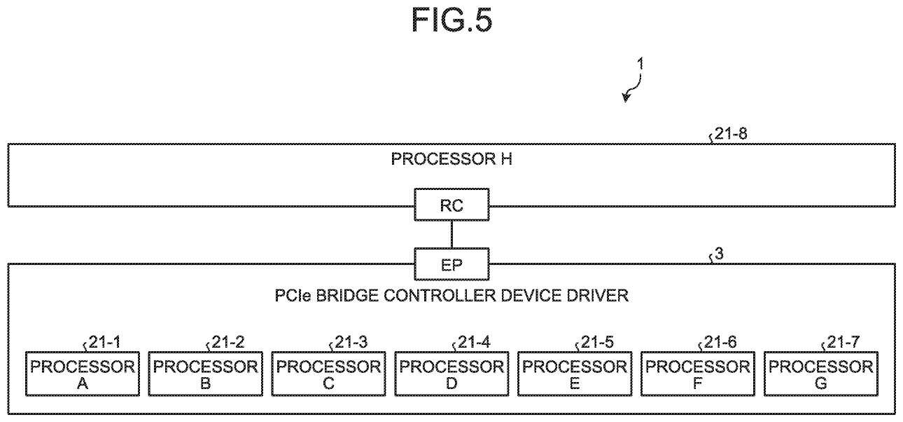

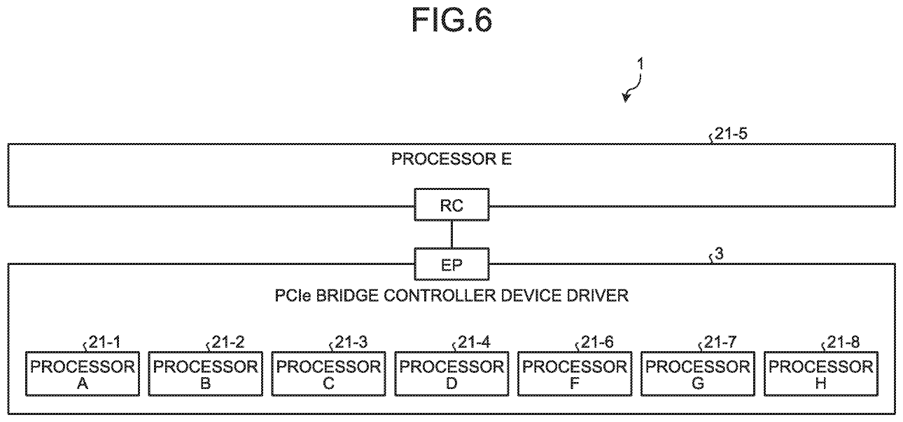

The following describes how the processor 21 of the platform 2 recognizes the processors 21 of the other platforms 2, with reference to FIGS. 5 and 6. FIGS. 5 and 6 are diagrams illustrating examples of how any one of the platforms recognizes the other of the platforms in the information processing system according to the present embodiment.

In a state in which the communication is performed between the processors 21 of the respective platforms 2, the OS (for example, Device Manager of Windows (registered trademark)) executed by each of the processors 21 can recognize only the relay device 3, and therefore, need not directly manage the processors 21 of the other platforms 2 serving as connection destinations. In other words, a device driver of the relay device 3 manages the processors 21 of the platforms 2 connected to the relay device 3.

Accordingly, no device driver needs to be prepared to operate the processors 21 of the platforms 2 serving as the transmission source and the transmission destination, and the communication between the platforms 2 can be performed by only performing the communication processing with the relay device 3 using the device driver of the relay device 3.

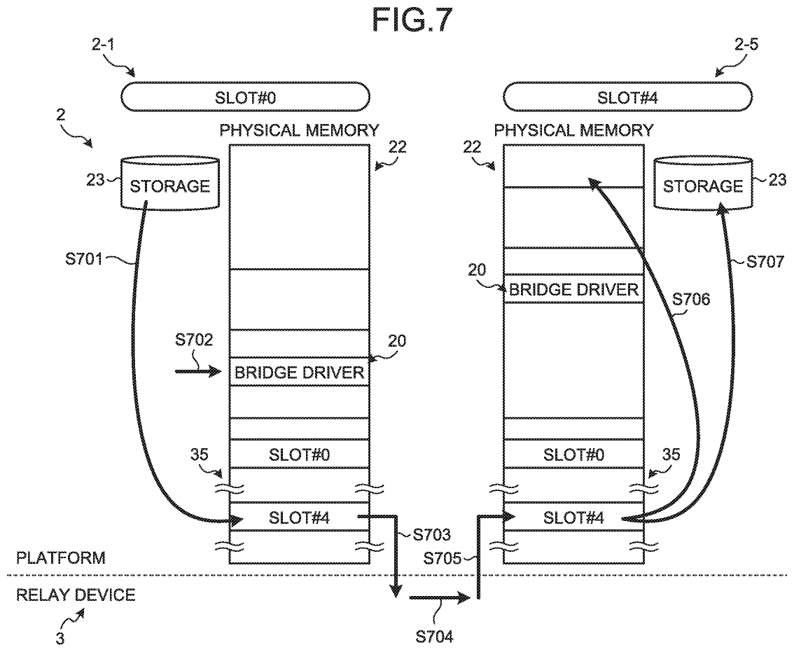

The following describes a method for data transfer between the platforms 2 through the relay device 3 in the information processing system 1, with reference to FIG. 7. FIG. 7 is a diagram for explaining an example of the method for data transfer between the processors through the relay device in the information processing system according to the present embodiment.

In the example illustrated in FIG. 7, a case will be described where data is transferred from the platform 2-1 connected to slot #0 to the platform 2-5 connected to slot #4.

The platform 2-1 serving as the transmission source stores data (hereinafter, called transmission data) to be transmitted by, for example, software from, for example, a storage 23 provided on the platform 2-1 into a memory area 35 of the platform 2-1 (Step S701). The memory area 35 may be a portion of a communication buffer in which data to be transferred is temporarily stored. The memory area 35 is an area provided in the same size as that of, for example, the memory 22 on each of the platforms 2. The memory area 35 is divided according to the number of the slots 305. Divided storage areas of the memory area 35 are each associated with any one of the slots 305. For example, a storage area in the memory area 35 represented as slot #0 is associated with the platform 2-1 connected to slot #0, and a storage area in the memory area 35 represented as slot #4 is associated with the platform 2-5 connected to slot #4. The platform 2-1 stores the transmission data in an area (in this case, slot #4) of the memory area 35 assigned to the slot 305 of the transmission destination.

Based on the storage area in the memory area 35 of the platform 2, the bridge driver 20 acquires or generates slot information indicating the slot 305 of the transmission destination and address information indicating an address in the divided area in the memory area 35 of the transmission destination (Step S702).

At the EP of the transmission source, the bridge driver 20 passes transfer data including the slot information, the address information, and the transmission data to the relay device 3 (Step S703). In this way, the relay device 3 transfers the transfer data to the platform 2-5 serving as the transmission destination by connecting the slot 305 of the transmission source to the slot 305 of the transmission destination in an EP-to-EP manner based on the slot information (Step S704). Based on the slot information and the address information, the bridge driver 20 of the transmission destination stores the transmission data (or the transfer data) in an area having the address indicated by the address information in the storage area corresponding to slot #4 of the memory area 35 of the platform 2 serving as the transmission destination (Step S705).

On the platform 2-5 serving as the transmission destination, for example, a computer program reads the transmission data stored in the memory area 35, and moves the transmission data to the memory (local memory) 22 and the storage 23 (Steps S706 and S707).

In the above-described manner, the data (transfer data) is transferred from the platform 2-1 serving as the transmission source to the platform 2-5 serving as the transmission destination.

In the above-described configuration, when an abnormality has occurred in the communication between the platform 2-1 (host PC) and the platforms 2-2 to 2-8 (computing units that perform, for example, the AI inference processing and the image processing) through the slots 305 (expansion bus), it is difficult to determine whether the abnormality in the communication between the host PC and the computing units is caused by hardware or software. Thus, no appropriate error handling (recovery) can be performed in a manner suited to a cause of the abnormality in the communication between the host PC and the computing units through the expansion bus.

Therefore, in the present embodiment, the power supply control microcomputer 302 of the relay device 3 is provided with the following functions such that, when an abnormality has occurred in the communication between the host PC and the computing units, it is possible to determine whether the cause of the abnormality in the communication is hardware or software, and an appropriate error handling can be performed in a manner suited to the cause of the abnormality in the communication between the host PC and the computing units through the expansion bus.

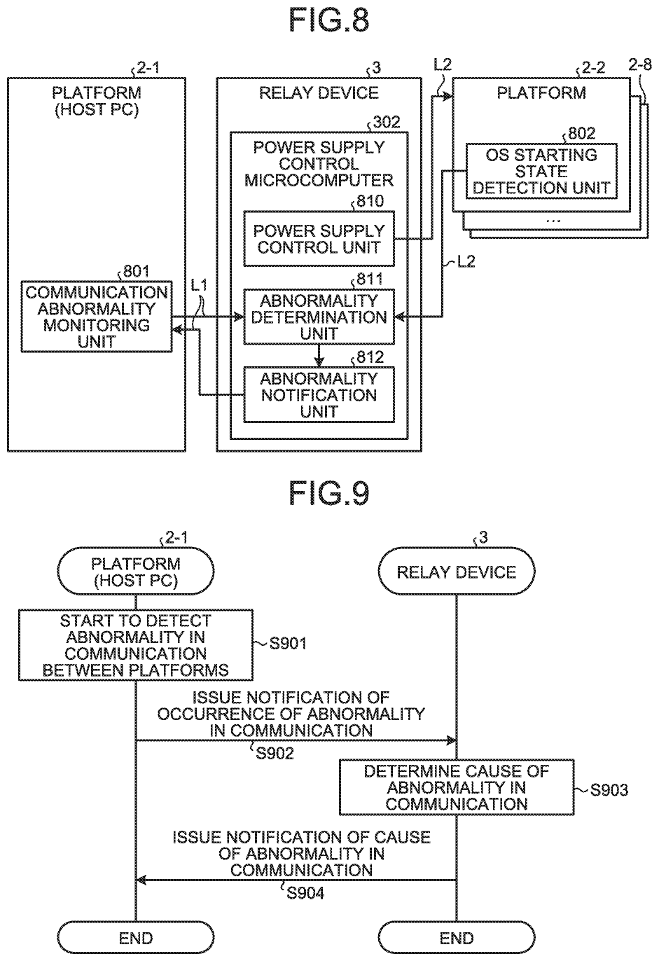

FIG. 8 is a block diagram illustrating an example of a functional configuration of the information processing system 1 according to the present embodiment. A function of the platform 2-1 (host PC) illustrated in FIG. 8 is performed as a result of reading and executing a software program stored in the memory 205 using the processor 21-1. Functions of the platforms (computing units) 2-2 to 2-8 illustrated in FIG. 8 are performed as a result of reading and executing software programs incorporated in the OS stored in the memory 205 using the processor 21-2. A function of the relay device 3 illustrated in FIG. 8 is performed as a result of reading and executing a software program stored in the memory included in the power supply control microcomputer 302 using the processor included in the power supply control microcomputer 302.

First, a functional configuration of the platform 2-1 will be described.

As illustrated in FIG. 8, the platform 2-1 according to the present embodiment includes a communication abnormality monitoring unit 801 as a functional component. The communication abnormality monitoring unit 801 detects the abnormality in the communication between the platform 2-1 (host PC) and the other platforms 2-2 to 2-8 (computing units) through the slots 305 (communication between the host PC and the computing units in a virtual LAN environment). In the present embodiment, when the communication abnormality monitoring unit 801 has detected the abnormality in the communication between the platform 2-1 and the other platforms 2-2 to 2-8, the communication abnormality monitoring unit 801 outputs a determination instruction signal serving as a signal for giving an instruction to determine causes of the abnormality in the communication to the relay device 3 through the signal line L1 connected to dedicated terminals, such as general-purpose input/output (GPIO) terminals.

When the communication abnormality monitoring unit 801 has been notified of determination results of the causes of the detected abnormality in the communication from the relay device 3 through the signal line L1, the communication abnormality monitoring unit 801 performs an error handling according to one of the determination results provided as the notification. Examples of the error handling include checking connection states of the platforms 2 to the slots 305, checking states of the supply of power from the external power supply unit to the platforms 2, checking starting states of the OS's of the platforms 2, and rebooting.

In the present embodiment, the communication abnormality monitoring unit 801 is notified from the relay device 3 of the determination results of the causes of the abnormality in the communication between the platform 2-1 and all the other platforms 2-2 to 2-8. The communication abnormality monitoring unit 801 identifies a cause of the abnormality in the communication between the platforms 2 from which the abnormality has been detected from among the causes of the abnormality in the communication provided as the notification, and performs an error handling according to the identified cause of the abnormality in the communication.

Subsequently, a functional configuration of the platform 2-2 will be described. Although the following describes the functional configuration of the platform 2-2, each of the platforms 2-3 to 2-8 serving as the computing unit also has the same functional configuration.

As illustrated in FIG. 8, the platform 2-2 according to the present embodiment includes an OS starting state detection unit 802 as a functional component. After the power supply control microcomputer 302 has supplied the power from the external power supply unit to the platform 2-2 and the OS of the platform 2-2 has begun to start, the OS starting state detection unit 802 detects whether the OS has started.

When the OS of the platform 2-2 has started, the OS starting state detection unit 802 outputs a start signal indicating that the platform 2-2 has started to the relay device 3 through the signal line L2 connected to the dedicated terminals, such as the GPIO terminals. For example, the OS starting state detection unit 802 sets the start signal to a high level if the OS of the platform 2-2 has started normally, or keeps the start signal at a low level if an abnormality has been detected in the starting of the OS of the platform 2-2.

Subsequently, a functional configuration of the relay device 3 will be described.

As illustrated in FIG. 8, the power supply control microcomputer 302 of the relay device 3 according to the present embodiment includes a power supply control unit 810, an abnormality determination unit 811, and an abnormality notification unit 812, as functional components. The power supply control unit 810 controls the supply of power to the platforms 2. In the present embodiment, the power supply control unit 810 outputs a power supply control signal to the external power supply unit (not illustrated) to control the supply of power from the power supply unit to the platforms 2. The power supply control signal is a signal that instructs a start of the supply of power to the platforms 2 or a shutdown of the supply of power to the platforms 2.

When the communication abnormality monitoring unit 801 has detected the abnormality in the communication, the abnormality determination unit 811 determines, based on electrical signals from the platforms 2-2 to 2-8, whether the abnormality in the communication is caused by hardware or software. In the present embodiment, when the communication abnormality monitoring unit 801 has detected the abnormality in the communication, and the determination instruction signal for giving an instruction to determine the causes of the detected abnormality in the communication has been received from the communication abnormality monitoring unit 801 through the dedicated terminals, such as the GPIO terminals, the abnormality determination unit 811 determines whether the abnormality in the communication is caused by hardware or software.

In the present embodiment, the abnormality determination unit 811 determines which of a plurality of candidates for the abnormality in the communication caused by hardware and software corresponds to the abnormality in the communication detected by the communication abnormality monitoring unit 801, based on an electrical signal received from the platform 2-2 through the signal line L1 connected to the dedicated terminals, such as the GPIO terminals. As a result, even when a plurality of causes can cause the abnormality in the communication between the platform 2-1 and the platforms 2-2 to 2-8, the cause of the abnormality in the communication can be determined.

The candidates for the abnormality in the communication caused by hardware include a state in which any one of the platforms 2-2 to 2-8 is not connected to corresponding one of the slots 305-2 to 305-8. Accordingly, the cause of the abnormality in the communication between the platform 2-1 and the platforms 2-2 to 2-8 can be determined to be that one of the platforms 2-2 to 2-8 is not connected to the slot 305. In the present embodiment, if no voltage is applied to any one of the signal lines L2 to L8 connected to the dedicated terminals, such as the GPIO terminals, the abnormality determination unit 811 determines that the abnormality in the communication has occurred because any one the platforms 2-2 to 2-8 is not connected to corresponding one of the slots 305-2 to 305-8.

The candidates for the abnormality caused by hardware include a state in which any one of the platforms 2-2 to 2-8 is supplied with no power. Accordingly, the cause of the abnormality in the communication between the platform 2-1 and the platforms 2-2 to 2-8 can be determined to be that any one of the platforms 2-2 to 2-8 is supplied with no power. In the present embodiment, if the abnormality determination unit 811 has not received a signal providing a notification that the OS has started from each of the platforms 2-2 to 2-8 within a preset time after an instruction to turn on the power is given to the platforms 2-2 to 2-8 through the dedicated terminals, such as the GPIO terminals, the abnormality determination unit 811 determines that the abnormality in the communication has occurred because any one of the platforms 2-2 to 2-8 is supplied with no power.

The candidates for the abnormality caused by software include a state in which an abnormality is present in the starting state of the OS executed by any one of the platforms 2-2 to 2-8. Accordingly, the cause of the abnormality in the communication between the platform 2-1 and the platforms 2-2 to 2-8 can be determined to be that the OS of any one of the platforms 2-2 to 2-8 has not started normally. In the present embodiment, if the start signals indicating that the OS's of the platforms 2-2 to 2-8 have started have not been received from the platforms 2-2 to 2-8 through the signal lines L1 to L8 connected to the dedicated terminals, such as the GPIO terminals, the abnormality determination unit 811 determines that the abnormality in the communication has occurred because an abnormality is present in any one of the starting states of the OS's. For example, if any one of the start signals received from the platforms 2-2 to 2-8 remains at the low level without turning to the high level, the abnormality determination unit 811 determines that the abnormality in the communication has occurred because an abnormality is present in the starting states of the OS's.

In the present embodiment, the abnormality determination unit 811 determines whether the abnormality in the communication between the platform 2-1 and the platforms 2-2 to 2-8 is caused by hardware or software, based on the electrical signals received from the platforms 2-2 to 2-8 at a preset period. The abnormality determination unit 811 stores the determination result in a register (not illustrated).

In the present embodiment, when the determination instruction signal has been received from the communication abnormality monitoring unit 801, the abnormality determination unit 811 re-determines whether the abnormality in the communication between the platform 2-1 and the platforms 2-2 to 2-8 is caused by hardware or software. The abnormality determination unit 811 stores the determination result as an updated determination result of the cause of the abnormality in the communication between the platform 2-1 and the platforms 2-2 to 2-8 in the register (not illustrated).

In the present embodiment, when the abnormality determination unit 811 determines the cause of the abnormality in the communication between the platform 2-1 and the platforms 2-2 to 2-8, the abnormality determination unit 811 determines the causes of the abnormality in the communication between the platform 2-1 and all the other platforms 2-2 to 2-8.

In addition, in the present embodiment, when the abnormality determination unit 811 determines the cause of the abnormality in the communication, the abnormality determination unit 811 first determines whether the abnormality in the communication is caused by the state in which any one of the platforms 2 is not connected to corresponding one of the slots 305. If it is determined that the abnormality in the communication is caused by the state in which the platform 2 is not connected to the slot 305, the abnormality determination unit 811 stores the determination result for the platform 2 in the register (not illustrated).

Subsequently, for each of the platforms 2 that is not determined to correspond to the abnormality in the communication due to the state of not being connected to corresponding one of the slots 305, the abnormality determination unit 811 determines whether the abnormality in the communication is caused by the state in which the platform 2 is supplied with no power. If it is determined that the abnormality in the communication is caused by the state in which the platform 2 is supplied with no power, the abnormality determination unit 811 stores the determination result for the platform 2 in the register (not illustrated).

Finally, for each of the platforms 2 that is not determined to correspond to the abnormality in the communication due to the state of being supplied with no power, the abnormality determination unit 811 determines whether the abnormality in the communication is caused by the state in which an abnormality is present in the starting state of the OS executed by the platform 2. If it is determined that the abnormality in the communication is caused by the state in which the abnormality is present in the starting state of the OS executed by the platform 2, the abnormality determination unit 811 stores the determination result for the platform 2 in the register (not illustrated).

In other words, the abnormality determination unit 811 determines the cause of the abnormality in the communication by determining whether the abnormality in the communication is caused by the state in which any one of the platforms 2 is not connected to corresponding one of the slots 305, whether the abnormality in the communication is caused by the state in which any one of the platforms 2 is supplied with no power, and whether the abnormality in the communication is caused by the state in which an abnormality is present in the starting state of the OS executed by any one of the platforms 2, in this order. For each of the platforms 2 not corresponding to any one of the causes of the abnormality in the communication, the abnormality determination unit 811 stores the fact that the platform 2 is normal or that the cause of the abnormality in the communication is unknown as the determination result of the abnormality in the communication in the register (not illustrated).

The abnormality notification unit 812 notifies the platform 2-1 of the determination result of whether the abnormality in the communication between the platform 2-1 (host PC) and the platforms 2-2 to 2-8 (computing units) is caused by hardware or software.

Accordingly, when the abnormality has occurred in the communication between the platform 2-1 (host PC) and the platforms 2-2 to 2-8 (computing units) through the slots 305, whether the abnormality in the communication is caused by hardware or software can be determined. As a result, an appropriate error handling can be performed in a manner suited to the cause of the abnormality in the communication between the platform 2-1 and the platforms 2-2 to 2-8 through the slots 305. In the present embodiment, the abnormality notification unit 812 notifies the platform 2-1 through the signal line L1 of the updated determination result of the cause of the abnormality in the communication among the platforms 2 stored in the register (not illustrated).

The following describes an example of a flow of processing of determining the abnormality in the communication in the information processing system 1 according to the present embodiment, using FIG. 9. FIG. 9 is a sequence diagram illustrating the example of the flow of the processing of determining the abnormality in the communication in the information processing system according to the present embodiment.

After the platform 2-1 starts the communication between the platform 2-1 and the other platforms 2-2 to 2-8 through the slots 305, the communication abnormality monitoring unit 801 of the platform 2-1 starts to detect an abnormality in the communication between the platform 2-1 and the other platforms 2-2 to 2-8 through the slots 305 (Step S901).

If the communication abnormality monitoring unit 801 detects the abnormality in the communication between the platform 2-1 and the other platforms 2-2 to 2-8 through the slots 305, the communication abnormality monitoring unit 801 notifies the relay device 3 of the determination instruction signal via serial communication, such as Inter-Integrated Circuit (I²C) (registered trademark) serial communication, through the signal line L1 (Step S902).

After receiving the determination instruction signal as the notification, the abnormality determination unit 811 of the relay device 3 determines, based on the electrical signals received from the platforms 2-2 to 2-8, whether the abnormality in the communication is caused by hardware or software (Step S903). In other words, the abnormality determination unit 811 determines the cause of the abnormality in the communication between the platform 2-1 and the other platforms 2-2 to 2-8.

The abnormality notification unit 812 of the relay device 3 notifies the platform 2-1 of the determination result of whether the abnormality in the communication between the platform 2-1 and the other platforms 2-2 to 2-8 is caused by hardware or software via the serial communication, such as the I²C (registered trademark) serial communication, through the signal line L1 (Step S904). In other words, the abnormality notification unit 812 issues the notification of the cause of the communication between the platform 2-1 and the other platforms 2-2 to 2-8.

As described above, with the information processing system 1 according to the present embodiment, when the abnormality has occurred in the communication between the platform 2-1 (host PC) and the platforms 2-2 to 2-8 (computing units) through the slots 305, whether the abnormality in the communication is caused by hardware or software can be determined. As a result, an appropriate error handling can be performed in a manner suited to the cause of the abnormality in the communication between the platform 2-1 and the platforms 2-2 to 2-8 through the slots 305.

With the information processing system 1 according to the present embodiment, the determination is made based on the electrical signals from the computing units as to which of a plurality of candidates for the abnormality in the communication caused by hardware and software corresponds to the abnormality in the communication between the host PC and the computing units through the slots 305. As a result, even when a plurality of causes can cause the abnormality in the communication between the host PC and the computing units, the cause of the abnormality in the communication can be determined.

With the information processing system 1 according to the present embodiment, the candidates for the abnormality caused by hardware in the communication between the host PC and the computing units through the slots 305 include the state in which any one of the computing units is not connected to the slot 305. Accordingly, the cause of the abnormality in the communication between the host PC and the computing units can be determined to be that one of the computing units is not connected to the slot 305.

With the information processing system 1 according to the present embodiment, the candidates for the abnormality caused by hardware in the communication between the host PC and the computing units through the slots 305 include the state in which any one of the computing units is supplied with no power. Accordingly, the cause of the abnormality in the communication between the host PC and the computing units can be determined to be that any one of the computing units is supplied with no power.

With the information processing system 1 according to the present embodiment, the candidates for the abnormality caused by software in the communication between the host PC and the computing units through the slots 305 include the abnormality in the starting state of the OS executed by any one of the computing units. Accordingly, the cause of the abnormality in the communication between the host PC and the computing units can be determined to be that the OS of any one of the computing units has not started normally.

Although the embodiment above has been described by exemplifying the PCIe as an input-output (I/O) interface for each component, the I/O interface is not limited to the PCIe. For example, the I/O interface for each component only needs to be a technique that allows data transfer between a device (peripheral controller) and processors through a data transfer bus. The data transfer bus may be a general-purpose bus that can transfer data at high speed in a local environment (for example, one system or one device) provided, for example, in one housing. The I/O interface may be either a parallel interface or a serial interface.

The I/O interface only needs to have a configuration allowing a point-to-point connection and allowing serial transfer of the data on a packet-by-packet basis. In the case of the serial transfer, the I/O interface may have a plurality of lanes. The I/O interface may have a layer structure including a transaction layer that generates and decodes packets, a data link layer that performs, for example, error detection, and a physical layer that performs serial/parallel conversion. The I/O interface may include, for example, a root complex disposed at the hierarchically top level and including one or a plurality of ports, an endpoint serving as an I/O device, switches for increasing the ports, and a bridge that converts protocols. The I/O interface may multiplex the data to be transmitted with clock signals using a multiplexer, and transmit the result. In this case, a receiving side may use a demultiplexer to separate the data from the clock signals.

According to one aspect of this disclosure, an appropriate error handling can be performed in a manner suited to the cause of the abnormality in the communication between the first platform and the second platform through the expansion bus.

According to another aspect of this disclosure, an appropriate error handling can be performed in a manner suited to the cause of the abnormality in the communication between the first platform and the second platform through the expansion bus.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A system comprising:
a first platform;
a second platform; and
a relay device including an expansion bus that connects to the first platform and the second platform, wherein
the first platform includes a processor that detects an abnormality in communication between the first platform and the second platform through the expansion bus, and
the relay device includes:
a communication control microcomputer that controls the communication between the first platform and the second platform through the expansion bus; and
a power supply control microcomputer that controls supply of power from an external power supply to the second platform, and that, after the abnormality has been detected in the communication between the first platform and the second platform through the expansion bus, determines, based on an electrical signal from the second platform, that the abnormality in the communication between the first platform and the second platform through the expansion bus is caused by one of hardware and software, and notify the first platform of a result of the determination.

2. The system according to claim 1, wherein the power supply control microcomputer determines, based on the electrical signal from the second platform, which of a plurality of candidates for the abnormality in the communication caused by the hardware and the software corresponds to the abnormality in the communication between the first platform and the second platform through the expansion bus.

3. The system according to claim 2, wherein the candidates for the abnormality in the communication between the first platform and the second platform through the expansion bus caused by the hardware include a state in which the second platform is not connected to the expansion bus.

4. The system according to claim 2, wherein the candidates for the abnormality in the communication between the first platform and the second platform through the expansion bus caused by the hardware include a state in which the second platform is supplied with no power.

5. The system according to claim 2, wherein the candidates for the abnormality in the communication between the first platform and the second platform through the expansion bus caused by the software include an abnormality in a starting state of an operating system executed by the second platform.

6. A device comprising:
an expansion bus that connects to a first platform and a second platform;
a communication control microcomputer that controls communication between the first platform and the second platform through the expansion bus; and
a power supply control microcomputer that controls supply of power to the second platform, and that, after an abnormality has been detected in the communication between the first platform and the second platform through the expansion bus, determines, based on an electrical signal from the second platform, that the abnormality in the communication between the first platform and the second platform through the expansion bus is caused by one of hardware and software, and notify the first platform of a result of the determination.
